(19) United States
(12) Patent Application Publication
(10) Pub. No.: US 2017/0334407 A1
(43) Pub. Date: Nov. 23, 2017

(54) WINDSHIELD WIPER CONNECTOR

(71) Applicant: Pylon Manufacturing Corporation, Deerfield Beach, FL (US)

(72) Inventor: Hiroshi Kawashima, Sunrise, FL (US)

(21) Appl. No.: 15/600,254

(22) Filed: May 19, 2017

Related U.S. Application Data
(60) Provisional application No. 62/338,834, filed on May 19, 2016.

(51) Int. Cl. B60S 1/40; B60S 1/38

(52) U.S. Cl. CPC B60S 1/4077; B60S 1/3853

(57) ABSTRACT

A connector for a windshield wiper, and a wiper blade assembly including same, that accommodates slotted receiving portions of windshield wiper arms. The connector for connecting a windshield wiper assembly to a wiper arm may have a peripheral wall having at least two opposing peripheral side walls and a top surface extending from one of the two opposing peripheral side walls to the other. The opposing peripheral side walls may each have a guide pin aligned with one another and sized to be capable of slidably engaging slots of windshield wiper arm.

### CROSS REFERENCE TO RELATED APPLICATIONS

This application claims the benefit of U.S. Provisional Application No. 62/338,834 filed May 19, 2016, the disclosure of which is hereby incorporated herein by reference in its entirety.

### TECHNICAL FIELD

This invention relates in general to windshield wipers, and more particularly, to an improved connector for a windshield wiper that allows the windshield wiper to be attached to windshield wiper arm configurations with a slotted receiving portion. The invention is also directed to windshield wipers incorporating these novel connectors.

### BACKGROUND OF THE INVENTION

There are a variety of wiper arms on which wiper blades are provided as original equipment. These various wiper arms have hooks, pins, or other configurations which may connect to the wiper blade with or without connectors. These various configurations have created a problem in the replacement market because wiper blade providers are required to have multiple wiper blade configurations to accommodate all of the existing wiper arms. It is therefore advantageous to have attachment structures that can accommodate a host of arms to reduce the complexity and cost associated with this problem.

The need to attach replacement windshield wiper blades to multiple arms has been addressed to some degree. For example, windshield wiper blades have been designed to work with various hook-type wiper arms having different sizes. Connectors may also be configured to receive either a pin-type arm or a hook arm. While these connectors may increase the usefulness of a given windshield wiper such that it can be used with different wiper arm types, the connectors are often expensive and have a complicated structure that is difficult and time-consuming to manufacture

Thus, there is a need for inexpensive connectors that are capable of securing a windshield wiper blade to a variety of arms. It would also be desirable to have a windshield wiper connector that can be fabricated or molded as a single piece at low-cost, and that can accommodate a variety of wiper arms. The disclosed concepts provide a low-cost windshield wiper connector capable of attachment to a variety of windshield wiper arms for the purpose of reducing the amounts of inventory parts required to supply a vehicle market that uses a wide variety of windshield wiper arm types.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

This disclosure is generally directed to novel connectors for windshield wiper blades. More particularly, the disclosure relates, in part, to a single piece windshield wiper connector that can accommodate multiple windshield wiper arms having varying slotted locking mechanisms.

In certain embodiments the connector for connecting a windshield wiper assembly to a wiper arm may have a peripheral wall having at least two opposing peripheral side walls and a top surface extending from one of the two opposing peripheral side walls to the other. The opposing peripheral side walls may each have a guide pin sized to be capable of slideably engaging slots on the slotted receiving portions of a windshield wiper arm. In some embodiments, the connector may further have a locking tab in the top surface sized such that it is capable of engaging a locking aperture on the top surface of the slotted receiving portion of the windshield wiper arm.

In certain embodiments a wiper blade assembly may include a wiper strip, a force distribution structure and a connector have a peripheral wall having at least two opposing peripheral side walls and a top surface extending from one of the two opposing peripheral side walls to the other. The opposing peripheral side walls may each have a guide pin sized to be capable of slideably engaging slots on the slotted receiving portions of a windshield wiper arm. In some embodiments, the connector may further have a locking tab in the top surface sized such that it is capable of engaging a locking aperture on the top surface of the slotted receiving portion of the windshield wiper arm.

### BRIEF DESCRIPTION OF THE DRAWINGS

FIG. 1 is a top perspective view of an embodiment of a connector of the disclosure.

FIG. 2 is a bottom perspective view of the connector shown in FIG. 1.

FIG. 3 is a top view of the connector shown in FIG. 1.

FIG. 4 is a bottom view of the connector shown in FIG. 1.

FIG. 5 is a side view of the connector shown in FIG. 1.

FIG. 6 is a side view of the connector shown in FIG. 1.

FIG. 7 is front end view of the connector shown in FIG. 1.

FIG. 8 is a back end view of the connector shown in FIG. 1.

FIG. 9 is a top perspective view of the connector shown in FIG. 1 attached to a windshield wiper blade.

FIG. 10 is a top perspective view of a windshield wiper arm for receiving connector of the disclosure.

FIG. 11 is a top perspective view of the connector shown in FIG. 1 engaging the wiper arm of FIG. 10.

### DETAILED DESCRIPTION OF THE PREFERRED EMBODIMENT

The following detailed description and the appended drawings describe and illustrate exemplary embodiments solely for the purpose of enabling one of ordinary skill in the relevant art to make and use the invention. As such, the detailed description and illustration of these embodiments are purely exemplary in nature and are in no way intended to limit the scope of the invention, or its protection, in any manner. It should also be understood that the drawings are not to scale and in certain instances details have been omitted, which are not necessary for an understanding of the present invention, such as conventional details of fabrication and assembly.

In one aspect, the invention is generally directed to a connector 1 for a windshield wiper (or a windshield wiper incorporating same) that allows a windshield wiper to be secured to a windshield wiper arm. In this aspect, the connector 1 may be designed for use with windshield wiper arms that use slotted receiving portions that secure the windshield wiper to the windshield wiper arm.

In certain embodiments the connector for connecting a windshield wiper assembly to a wiper arm may have a peripheral wall having at least two opposing peripheral side walls and a top surface extending from one of the two opposing peripheral side walls to the other. The opposing peripheral side walls may each have a guide pin sized to be capable of slideably engaging slots on the slotted receiving portions of a windshield wiper arm.

In some embodiments, the opposing side walls and/or the top surface of the connector may be raised along a portion of the front end. The raised side walls and/or top surface may provide a structure for the windshield wiper arm receiving portion to abut when engaged with the connector. Further, the raised side walls and/or top surface of the connector may provide a streamlined transition surface where the receiving portion of the wiper arm and front end of the connector meet. In further embodiments, the connector slopes downward from the proximity of the abutment with the receiving portion of the wiper arm towards the front end, further providing a streamlined look at the connector-wiper arm junction.

In some embodiments, the connector may further have a locking tab in the top surface sized such that it is capable of engaging a locking aperture on the top surface of the slotted receiving portion of the windshield wiper arm. In some embodiments, the locking tab may be cantilevered. The guide pins on the opposing peripheral side walls may provide a structure for assisting in maintaining proper positioning of the connector while slideably engaging the wiper arm. The guide pins may also provide proper positioning of the connector as it is slideably placed into the receiving portion of the windshield wiper arm, upon which the locking tab engages the locking aperture to finally maintain the position of the connector on the wiper arm.

In some embodiments, the connector may have at least two longitudinal internal support walls extending downward from the top surface, and substantially along the longitudinal length of the connector, and at least one rivet passage and arcuate rivet clip in each of the internal longitudinal support walls for accepting and securing a rivet of a wiper blade, thereby securing the connector to the wiper blade. In some of these embodiments, the connector may be capable of being secured to the mounting base of a windshield wiper blade assembly via the rivet through the mounting base. In some embodiments, the at least one rivet passage extends through one or both of the peripheral side walls. In additional embodiments, the connector may have at least one transverse internal support wall connecting the two longitudinal internal support walls and providing additional support and rigidity to the connector.

In some embodiments the connector may be fabricated as a single piece. In other embodiments the front portion of the connector may be fabricated as one piece, and the back portion of the connector may be fabricated as one piece.

In certain embodiments a wiper blade assembly may include a wiper strip, a force distribution structure and a connector have a peripheral wall having at least two opposing peripheral side walls and a top surface extending from one of the two opposing peripheral side walls to the other. The opposing peripheral side walls may each have a guide pin sized to be capable of slideably engaging slots on the slotted receiving portions of a windshield wiper arm. In some embodiments, the connector may further have a locking tab in the top surface sized such that it is capable of engaging a locking aperture on the top surface of the slotted receiving portion of the windshield wiper arm.

In certain embodiments the opposing side walls and/or the top surface of the connector may be raised along a portion of the front end, wherein the raised side walls and/or top surface may provide an abutment structure capable of abutting the windshield wiper arm receiving portion when the arm is engaged with the connector. In certain embodiments the raised side walls and/or top surface of the connector may provide a streamlined transition surface where the receiving portion of the wiper arm and front end of the connector meet. In certain embodiments the connector may slope downward from the proximity of the abutment structure towards the front end, further providing a streamlined look at the connector-wiper arm junction.

In certain embodiments, a locking tab in the top surface of the connector may be sized such that it is capable of engaging a locking aperture on the top surface of the slotted receiving portion of the windshield wiper arm. In certain embodiments the locking tab may be cantilevered.

In certain embodiments the guide pins on the opposing peripheral side walls of the connector may be capable of assisting in maintaining proper positioning of the connector while slideably engaging the wiper arm and providing proper positioning of the connector as it is slideably placed into the receiving portion of the windshield wiper arm, upon which the locking tab engages the locking aperture to finally maintain the position of the connector on the wiper arm. In certain embodiments, the connector of the wiper blade assembly may further include at least two longitudinal internal support walls extending downward from the top surface, and substantially along the longitudinal length of the connector.

In certain embodiments the connector of the wiper blade assembly may further include at least one rivet passage and arcuate rivet clip in each of the internal longitudinal support walls for accepting and securing a rivet of a wiper blade, thereby securing the connector to the wiper blade. In certain embodiments the connector may be fabricated as a single piece.

In some aspects, a wiper blade assembly of the disclosure may have a wiper blade having a rivet and a connector having a peripheral wall having two opposing side walls, a top surface having a flat back shelf and a sloped front shelf, a locking tab on the surface of the flat back shelf capable of engaging the locking aperture of a receiving portion of a wiper arm, at least two internal support walls, each of the two internal support walls having a rivet passage and an arcuate rivet clip for receiving the rivet of the wiper blade, and a guide pin on the surface of each of the two opposing side walls.

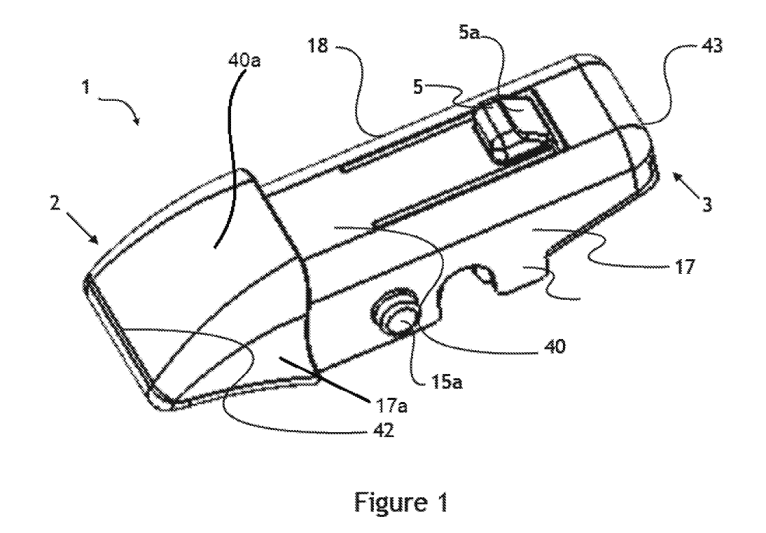

FIG. 1 illustrates a top perspective view of an embodiment of a connector 1 of the disclosure. The connector 1 has a front end 2 and a back end 3. For purposes of this disclosure, the back end 3 of the connector receives the wiper arm, and the front end 2 of the connector is opposite the back end 3. A peripheral wall 4 may extend around the periphery of the connector 1. The peripheral wall 4 may include a front portion 42, a back portion 43, and opposing side portions that connect the front and back portions, referred to as a first side 17 and a second side 18. A top surface 40 extends between opposing peripheral side walls 17, 18.

The opposing peripheral side walls 17, 18 may each have a guide pin 15a, 15b, the pins are sized to be capable of slideably engaging slots on slotted receiving portions of a windshield wiper arm. In some embodiments, the front portions of the opposing side walls 17a, 18b and/or the front portions of the top surface 40a of the connector may be raised relative to the respective back portions of the opposing side walls 17, 18, and top surface 40. In some embodiments the front portions of the opposing side walls 17a, 18a, may define a width which is greater than the width of the opposing side walls 17, 18 at the back end of the connector 1. Similarly, in some embodiments the front portions of the opposing side walls 17a, 18a, may define a width which is greater than the width of the opposing side walls 17, 18 at the guide pins 15a, 15b. The raised and/or wider side walls 17a, 18a and/or top surface 40a may provide a structure for the windshield wiper arm receiving portion to abut when engaged with the connector 1. Further, the raised and/or wider side walls and/or top surface 40a of the connector may provide a streamlined transition surface where the receiving portion of the wiper arm and front end of the connector 1 meet. In further embodiments, the connector 1 slopes downward from the proximity of the abutment with the receiving portion of the wiper arm towards the front end 2, further providing a streamlined look at the connector-wiper arm junction.

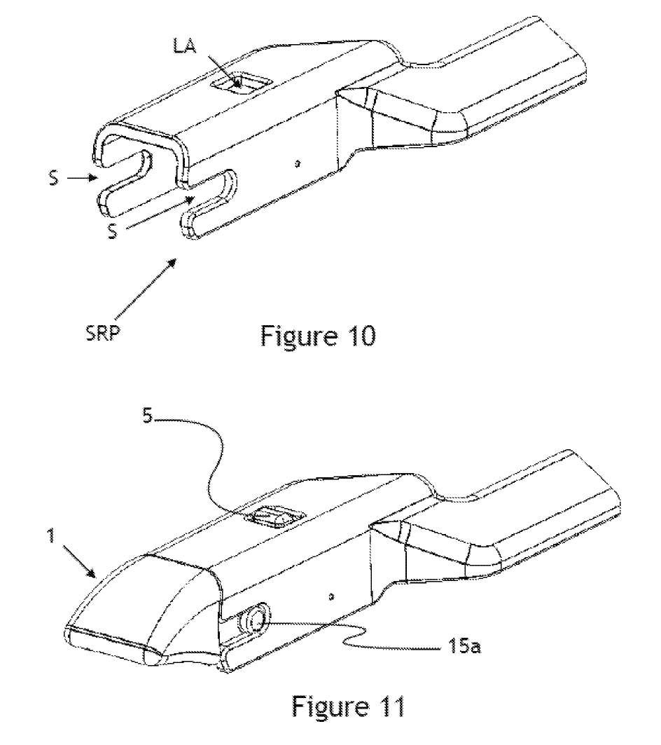

The top surface 40 of the connector 1 may also have a locking tab 5 in the top surface 40 sized such that it is capable of engaging a locking aperture LA (see FIG. 10) on the top surface of the slotted receiving portion SRP of a windshield wiper arm. In some embodiments, the locking tab 5 is cantilevered. As shown in FIG. 1, the locking tab may be structured with an angled face 5a such that the top surface of the slotted receiving portion SRP of a windshield wiper arm more readily slides over the locking tab and pushes it downward as the slotted receiving portion SRP receives the connector. Once the connector 1 is pushed completely into the slotted receiving portion SRP, the locking tab 5 protrudes into the locking aperture LA of the receiving portion (see FIG. 11) to “lock” the connector 1 into place.

The guide pins 15a, 15b on the opposing peripheral side walls 4 may provide a structure for assisting in maintaining proper positioning of the connector 1 while slidably engaging the wiper arm's slotted receiving portion SRP. The guide pins 15a, 15b also provide proper positioning of the connector 1 as it is slidably placed into the receiving portion of the windshield wiper arm, upon which the locking tab engages the locking aperture to finally maintain the position of the connector on the wiper arm.

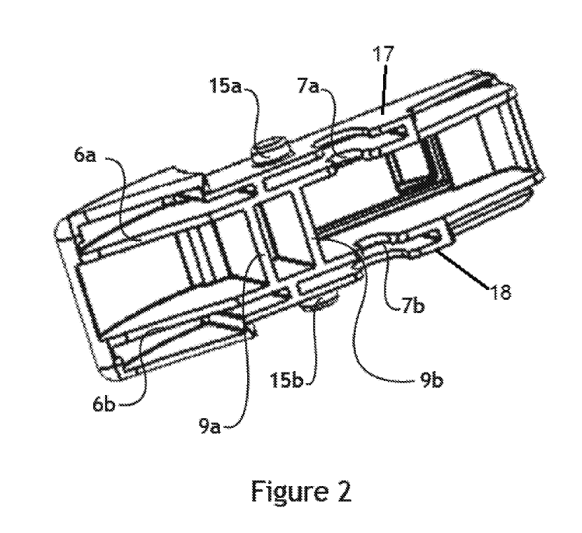

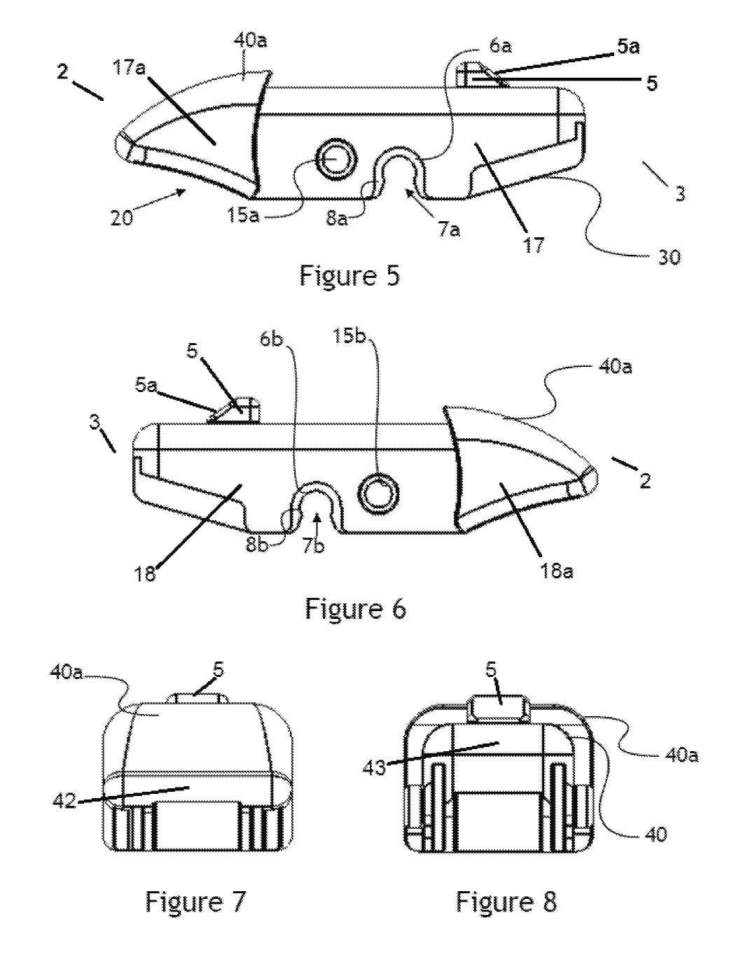

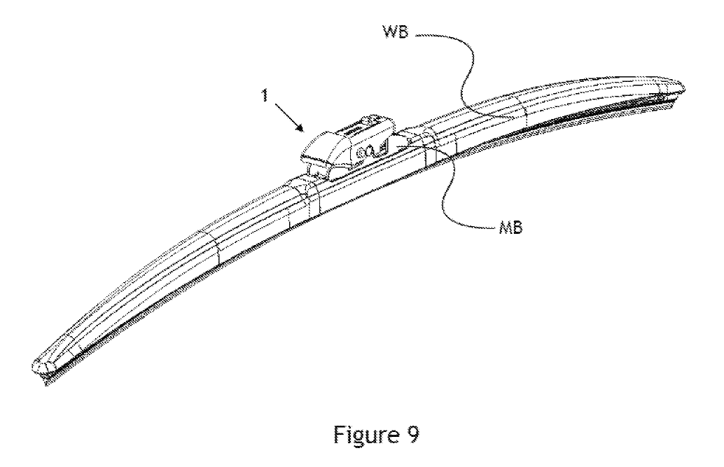

FIG. 2 illustrates a bottom perspective view of an embodiment of the connector 1 that shows the internal support structure having at least two longitudinal internal support walls 6a, 6b extending downward from the top surface, and substantially along the longitudinal length of the connector 1. The connector 1 may also have at least one rivet passage 7a, 7b and arcuate rivet clip 8a, 8b (see FIGS. 5 and 6) in each of the internal longitudinal support walls 6a, 6b for accepting and securing a rivet of a wiper blade to secure the connector to the wiper blade. The support walls can extend substantially along the length of the connector continuously, or intermittently, having gaps along the way. In particular, internal support walls 6a, 6b provide rigidity and structural strength to the connector 1. In some of these embodiments, the connector may be capable of being secured to the mounting base of a windshield wiper blade assembly via the rivet through the mounting base, as shown in FIG. 9. In some embodiments, the at least one rivet passage 7a, 7b may extend through one or both of the peripheral side walls, as illustrated in FIG. 2. In additional embodiments, the connector 1 may have at least one transverse internal support wall 9 (two walls 9a, 9b are shown in FIG. 2) connecting the two longitudinal internal support walls 6a, 6b and providing additional support and rigidity to the connector.

Those skilled in the art will recognize that connector 1 can be fabricated from any suitable material known in the art, including without limitation, rigid or elastic plastics, metals, synthetic and natural rubber compounds, etc. However, certain embodiments contemplate materials that can be molded such that connector 1 is fabricated as a single piece. In other embodiments the connecter can be fabricated in multiple pieces. For instance the wider front portion of the connector 1 may be fabricated as a separate cap which engages and is secured to the back portion of the connector through projections and recesses, detents that engage shoulders, or through any other known method of securing a cap to a connector known in the art.

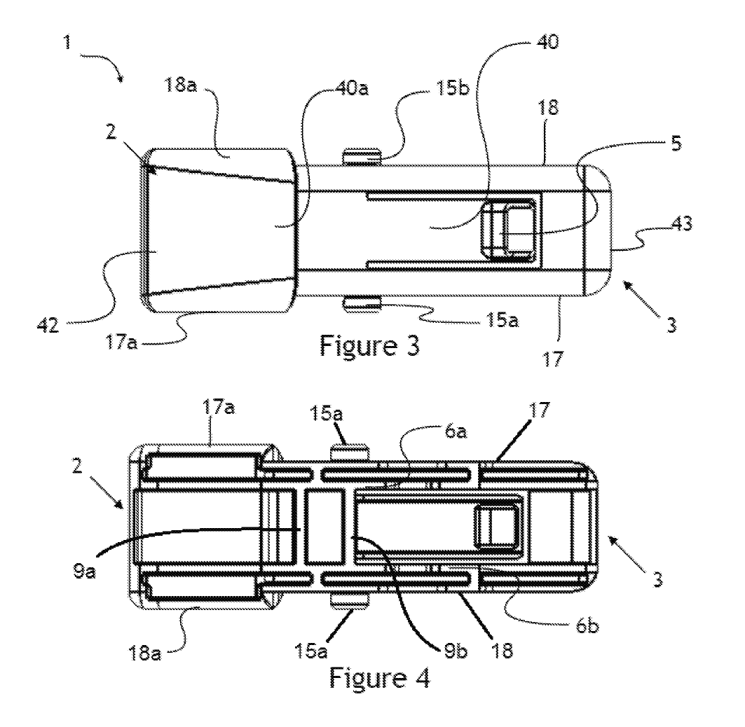

FIG. 3 is a top view of the embodiment of a connector 1 illustrated in FIGS. 1 and 2. As illustrated, the opposing side walls 17, 18 and/or the top surface 40 of the connector may be raised and/or wider a long a portion of the front end 2 (designated as 17a, 18a, and 40a) than they are at the back end 3 or at the guide pins 15a, 15b.

FIG. 4 is a bottom view of the embodiment of a connector 1 illustrated in FIGS. 1, 2, and 3. As illustrated, the internal support structure may have at least two longitudinal internal support walls 6a, 6b, and may further have one or more transverse internal support walls 9a, 9b. FIG. 4 also illustrates the raised opposing side walls 17a, 17b that may be configured such that the front end 2 of the connector 1 is wider than the back end 3.

FIGS. 5 and 6 are opposing side views of the embodiment of a connector 1 illustrated in FIGS. 1-4. As illustrated, the opposing side walls 17, 18 may have at least one rivet passage 7a, 7b and arcuate rivet clip 8a, 8b in each of the internal longitudinal support walls 6a, 6b for accepting and securing a rivet of a wiper blade mount to secure the connector 1 to a wiper blade. FIGS. 5 and 6 also illustrate the raised portion of the top surface 40a towards the front end 2. As further illustrated, the raised portion of the top surface 40a slopes downwards towards the front end 2. As also illustrated, the bottom portions 20, 30 of the front and back ends, respectively, of the connector 1 may be sloped upwards towards the top surface 40. This may allow for some freedom of movement of the wiper blade along the axis of the rivet as it pivots thereon.

FIG. 7 illustrates a front view of the embodiment of a connector 1 from the front end illustrated in FIGS. 1-6. FIG. 8 illustrates a back view of the embodiment of a connector 1 from the distal end illustrated in FIGS. 1-6. FIGS. 7 and 8 show the locking tab 5 extending upwards from the top surface 40 of the connector 1.

FIG. 9 illustrates an embodiment of a connector 1 of the disclosure as attached to a mounting base MB of a wiper blade WB. The wiper blade may be a traditional wiper blade having tournament style brackets that act as a force distribution structure. Alternatively the wiper blade may be a beam blade, which uses one or more spring-elastic beams as a force distribution structure. Alternatively, a hybrid wiper blade which uses one or more beams and one or more brackets to distribute force to a wiper blade may also be used.

FIG. 10 illustrates a slotted receiving portion SRP of a windshield wiper arm for engaging a connector 1 of the present disclosure. The slotted receiving portion SRP has slots S on opposing sides for engaging the guide pins 15a, 15b of a connector 1 of the disclosure. The slotted receiving portion SRP may also have a locking aperture LA for engaging the locking tab 5 of a connector 1 described herein.

FIG. 11 illustrates a slotted receiving portion SRP of a windshield wiper arm with a connector 1 pushed completely into the slotted receiving portion SRP. The guide pins 15a, 15b on the opposing peripheral side walls 4 provide a structure for assisting in maintaining proper positioning of the connector 1 while slideably engaging the slots S of the wiper arm's slotted receiving portion SRP. The guide pins 15a, 15b also provide proper positioning of the connector 1 as it is slideably placed into the receiving portion of the windshield wiper arm, upon which the locking tab engages the locking aperture to finally maintain the position of the connector on the wiper arm. The locking tab 5 protrudes into the locking aperture LA of the receiving portion to “lock” the connector 1 into place.

In certain embodiments, the connector 1 may be connected to the wiper blade prior to connecting to the wiper arm, In certain embodiments, the connector 1 may be connected to the wiper arm prior to being connected to the wiper blade. In certain embodiments, the connector 1 may either be first connected to the wiper arm or to the wiper arm.

Those skilled in the art will recognize that while the invention will most likely be used in conjunction with automobiles, it is suitable for use with any vehicle. For example, in addition to automobiles, trucks, buses, locomotives, aircrafts, or any other vehicle type that uses a windshield wiper can benefit from the invention.

While specific embodiments have been discussed to illustrate the invention, it will be understood by those skilled in the art that the descriptions herein are intended as illustrative, and not as limiting, and that variations in the embodiments can be made without departing from the spirit of the invention.

For example, any suitable material can be used to manufacture the connector. The number or position of the locking tabs, guide pins, or other mechanisms can vary so long as they are capable of performing their intended function.

We claim:

1. A connector comprising:
front and back ends, and
a peripheral wall having at least two opposing peripheral side walls and a top surface extending from one of the two opposing peripheral side walls to the other; the opposing peripheral side walls each comprising a guide pin; and
wherein the pins are sized to be capable of slideably engaging slots on slotted receiving portions of a windshield wiper arm.

2. The connector of claim 1 wherein the opposing side walls and/or the top surface of the connector may be raised along a portion of the front end, wherein the raised side walls and/or top surface may provide an abutment structure capable of abutting the windshield wiper arm receiving portion when the arm is engaged with the connector.

3. The connector of claim 2 wherein the raised side walls and/or top surface of the connector may provide a streamlined transition surface where the receiving portion of the wiper arm and front end of the connector meet.

4. The connector of claim 2 wherein the connector slopes downward from the proximity of the abutment structure towards the front end, further providing a streamlined look at the connector-wiper arm junction.

5. The connector of claim 1 further comprising a locking tab in the top surface sized such that it is capable of engaging a locking aperture on the top surface of the slotted receiving portion of the windshield wiper arm.

6. The connector of claim 5 wherein the locking tab is cantilevered.

7. The connector of claim 1 wherein the guide pins on the opposing peripheral side walls are capable of assisting in maintaining proper positioning of the connector while slideably engaging the wiper arm and providing proper positioning of the connector as it is slideably placed into the receiving portion of the windshield wiper arm, upon which the locking tab engages the locking aperture to finally maintain the position of the connector on the wiper arm.

8. The connector of claim 1 further comprising at least two longitudinal internal support walls extending downward from the top surface, and substantially along the longitudinal length of the connector.

9. The connector of claim 8 further comprising at least one rivet passage and arcuate rivet clip in each of the internal longitudinal support walls for accepting and securing a rivet of a wiper blade, thereby securing the connector to the wiper blade.

10. The connector of claim 1 wherein the connector is fabricated as a single piece.

11. A wiper blade assembly comprising:
a wiper strip;
a force distribution structure; and
a connector comprising:
a peripheral wall having at least two opposing peripheral side walls and a top surface extending from one of the two opposing peripheral side walls to the other; the opposing peripheral side walls each comprising a guide pin; and
wherein the pins are sized to be capable of slideably engaging slots on slotted receiving portions of a windshield wiper arm.

12. The wiper blade assembly of claim 11 wherein the opposing side walls and/or the top surface of the connector may be raised along a portion of the front end, wherein the raised side walls and/or top surface may provide an abutment structure capable of abutting the windshield wiper arm receiving portion when the arm is engaged with the connector.

13. The wiper blade assembly of claim 12 wherein the raised side walls and/or top surface of the connector may provide a streamlined transition surface where the receiving portion of the wiper arm and front end of the connector meet.

14. The wiper blade assembly of claim 12 wherein the connector slopes downward from the proximity of the abutment structure towards the front end, further providing a streamlined look at the connector-wiper arm junction.

15. The wiper blade assembly of claim 11 further comprising a locking tab in the top surface sized such that it is capable of engaging a locking aperture on the top surface of the slotted receiving portion of the windshield wiper arm.

16. The wiper blade assembly of claim 15 wherein the locking tab is cantilevered.

17. The wiper blade assembly of claim 11 wherein the guide pins on the opposing peripheral side walls are capable of assisting in maintaining proper positioning of the connector while slideably engaging the wiper arm and providing proper positioning of the connector as it is slideably placed into the receiving portion of the windshield wiper arm, upon which the locking tab engages the locking aperture to finally maintain the position of the connector on the wiper arm.

18. The wiper blade assembly of claim 11 further comprising at least two longitudinal internal support walls extending downward from the top surface, and substantially along the longitudinal length of the connector.

19. The wiper blade assembly of claim 18 further comprising at least one rivet passage and arcuate rivet clip in each of the internal longitudinal support walls for accepting and securing a rivet of a wiper blade, thereby securing the connector to the wiper blade.

20. The connector of claim 11 wherein the connector is fabricated as a single piece.
